(19) United States
(12) Patent Application Publication
(10) Pub. No.: US 2012/0274749 A1
(43) Pub. Date: Nov. 1, 2012

(54) STEREOSCOPIC VIDEO DISPLAY DEVICE

(76) Inventors: Io NAKAYAMA, Kanagawa (JP); Masahiro BABA, Kanagawa (JP); Yuki IWANAKA, Tokyo (JP); Takashi IDA, Kanagawa (JP)

(21) Appl. No.: 13/545,236

(22) Filed: Jul. 10, 2012

Related U.S. Application Data
(63) Continuation of application No. PCT/JP2010/000125, filed on Jan. 13, 2010.

(51) Int. Cl. H04N 13/04

(52) U.S. Cl. 348/51; 348/E13.026

(57) ABSTRACT

According to an embodiment, a stereoscopic video display device displays images for a plurality of view point directions on a displaying device while switching between the images at predetermined time intervals. The stereoscopic video display device includes a calculator configured to calculate a crosstalk amount of a first image for one view point direction, which is an image to be corrected, by using a pixel value of the first image, a pixel value of a second image for a view point direction different from that of the first image, the second image being an image to be displayed at a time before the first image, and characteristics data including response characteristics of the displaying device; and a corrector configured to correct the first image by using the crosstalk amount.

### CROSS-REFERENCE TO RELATED APPLICATIONS

This application is a continuation of PCT international application Ser. No. PCT/JP2010/000125 filed on Jan. 13, 2010 which designates the United States; the entire contents of which are incorporated herein by reference.

### FIELD

Embodiments described herein relate to a stereoscopic video display device that corrects crosstalk.

### BACKGROUND

There are stereoscopic video display devices that present stereoscopic images to a viewer by displaying images for the right eye and images for the left eye while switching between the images at regular time intervals, and opening/closing shutter glasses worn by the viewer in synchronization with the switching of the display.

With such a stereoscopic video display device, corrected images are presented to the viewer so as to reduce the amount of crosstalk between left and right images.

For example, in Japanese Patent Application Laid-open No. 2009-507401, a stereoscopic video display device calculates a leakage luminance from a right eye image to the left eye by a correction formula using a preset coefficient; subtracts the leakage luminance from a left eye image to be displayed next after the right eye image; and presents the left eye image to the viewer (the same is applicable to leakage from a left eye image to the right eye).

With the stereoscopic video display device described above, images are corrected by predicting leakage luminance by a correction formula using the coefficients. Accordingly, the predicted leakage luminance may be different from the actual luminance, and there is thus a disadvantage that crosstalk cannot be corrected on the basis of accurate prediction of an actual crosstalk amount.

### BRIEF DESCRIPTION OF THE DRAWINGS

FIGS. 1A and 1B are views each illustrating an external appearance of a stereoscopic video display device 1 according to a first embodiment;

FIG. 2 is a graph illustrating a variation of transmittance with time at one pixel of a liquid crystal panel;

FIG. 3 is a graph illustrating an example of a crosstalk amount at one pixel in an image;

FIG. 4 is a block diagram illustrating a configuration of a stereoscopic video display system including the stereoscopic video display device 1;

FIG. 5 is a flowchart illustrating processes of the stereoscopic video display device 1;

FIG. 6 is a flowchart illustrating processes of a first calculator 101a on an n-th original image to be processed;

FIG. 7 is a flowchart illustrating processes of a second calculator 101b on an n-th original image to be processed;

FIG. 8 is a flowchart illustrating processes of a crosstalk calculator 101c on an n-th original image to be processed;

FIG. 9 is a flowchart illustrating processes of a corrector 104 on an n-th original image to be processed;

FIG. 10 is a block diagram illustrating a configuration of a stereoscopic video display system including a stereoscopic video display device 10 according to a second embodiment;

FIG. 11 is a diagram illustrating an example of a translation table to E₂(x, y, c); and

FIG. 12 is a block diagram illustrating a configuration of a stereoscopic video display system including a stereoscopic video display device 200 according to a fourth embodiment.

### DETAILED DESCRIPTION

According to an embodiment, a stereoscopic video display device displays images for a plurality of view point directions on a displaying device while switching between the images at predetermined time intervals. The stereoscopic video display device includes a calculator configured to calculate a crosstalk amount of a first image for one view point direction, which is an image to be corrected, by using a pixel value of the first image, a pixel value of a second image for a view point direction different from that of the first image, the second image being an image to be displayed at a time before the first image, and characteristics data including response characteristics of the displaying device; and a corrector configured to correct the first image by using the crosstalk amount.

Various embodiments will be described below with reference to the drawings.

In the present specification and the drawings, components similar to those described before in relation to a drawing that has already been referred to will be designated by the same reference numerals and description thereof will not be repeated as appropriate.

### First Embodiment

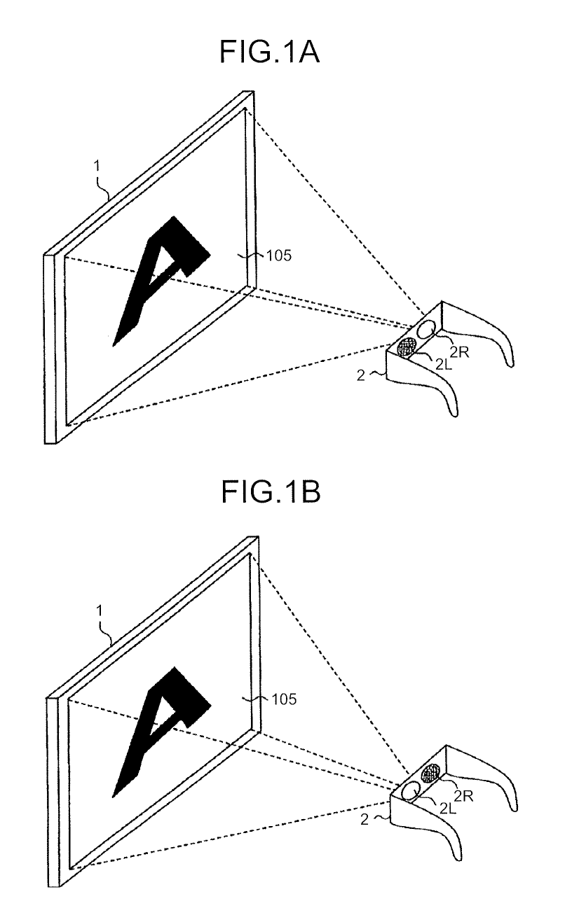

FIGS. 1A and 1B are views each illustrating an external appearance of a stereoscopic video display device 1 according to a first embodiment. For example, the stereoscopic video display device 1 may be a television set. The stereoscopic video display device 1 displays right eye images and left eye images having parallaxes from each other on a displaying device 105 while alternately switching between the right eye images and the left eye images so as to allow the viewer to perceive stereoscopic images. Herein, the right eye images refer to images to be presented to the right eye of the viewer. The left eye images refer to images to be presented to the left eye of the viewer.

The viewer wears liquid crystal shutter glasses 2 to view video on the displaying device 105. In FIG. 1A, the stereoscopic video display device 1 presents right eye images to the right eye (not illustrated) of the viewer through the liquid crystal shutter glasses 2 with an open right shutter part 2R.

In FIG. 1B, the stereoscopic video display device 1 presents left eye images to the left eye (not illustrated) of the viewer through the liquid crystal shutter glasses 2 with an open left shutter part 2L.

The liquid crystal shutter glasses 2 open and close left and right shutter parts 2L and 2R alternately in synchronization with the switching of the display of the right eye images and the left eye images. In this manner, the stereoscopic video display device 1 allows the viewer to perceive stereoscopic images. The displaying device 105 may be a liquid crystal display and includes a backlight and a liquid crystal panel.

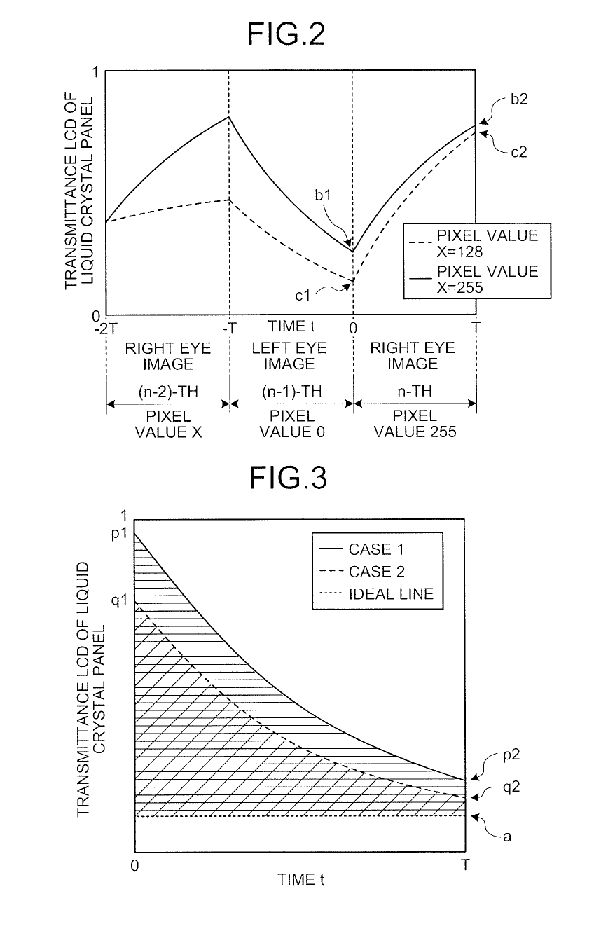

FIG. 2 is a graph illustrating a variation of transmittance with time at one pixel of the liquid crystal panel. The horizontal axis represents time t and the vertical axis represents the transmittance LCD of the liquid crystal panel. FIG. 2 illustrates a case of a right eye image displayed as an (n−2)-th image, a left eye image displayed as an (n−1)-th image and a right eye image displayed as an n-th image on the displaying device 105. Since pixels of the liquid crystal panel have response speed characteristics, it takes time until a certain set transmittance is reached. Moreover, a set transmittance may not be reached even at a display end time of an image (for example, time T for the right eye image displayed as the n-th image).

The solid line represents a variation of transmittance with time at one pixel of the liquid crystal panel when the right eye image displayed as the (n−2)-th image is set to a pixel value of 255, the left eye image displayed as the (n−1)-th image is set to a pixel value of 0, and the right eye image displayed as the n-th image is set to a pixel value of 255. The broken line represents a variation of transmittance with time at one pixel of the liquid crystal panel when the right eye image displayed as the (n−2)-th image is set to a pixel value of 128, the left eye image displayed as the (n−1)-th image is set to a pixel value of 0, and the right eye image displayed as the n-th image is set to a pixel value of 255. The pixel value of the right eye image displayed as the (n−2)-th image at the start time of the display is the same in both cases.

As is apparent from the drawing, the reached value of the transmittance of the liquid crystal panel varies depending on the differences in the pixel value of an image at a certain time even when the same pixel value is set for a subsequent image. The reached value refers to a transmittance at a time point when display of one image ends at one pixel of the liquid crystal panel. In the example of FIG. 2, the reached value varies, being b1 or c1, for example, even when the pixel value of the left eye image displayed as the (n−1)-th image is set to the same value as a result of using different values for the pixel value of the right eye image displayed as the (n−2)-th image.

Furthermore, when the pixel value of the right eye image displayed as the n-th image is set to 255 (a transmittance 1), the reached value of the left eye image displayed as the (n−1)-th image varies, and thus the reached value of the right eye image displayed as the n-th image also varies, being b2 or c2, for example. This is one factor causing crosstalk.

The stereoscopic video display device 1 according to this embodiment predicts the amount of crosstalk in an n-th image to be presented to either one eye from characteristics data of the displaying device and characteristics data of the liquid crystal shutter glasses 2 including response characteristics of the liquid crystal panel and the reached value of an (n−1)-th image to be presented to the other eye. The stereoscopic video display device 1 generates a corrected image on the basis of the predicted crosstalk amount and displays the corrected image. Note that whether to use the characteristics data of the liquid crystal shutter glasses 2 is optional.

FIG. 3 is a graph illustrating an example of a crosstalk amount at one pixel in an image. For simplification, the crosstalk amount that can be obtained only from the response characteristics of the liquid crystal panel is illustrated in FIG. 3. The horizontal axis represents time t and the vertical axis represents the transmittance LCD of the liquid crystal panel. All of the solid line, the broken line and the dotted line represent variations with time of the transmittance of the liquid crystal panel when the same pixel value is set. Between the cases represented by the solid line and the broken line, however, the reached values of the previous image are different, which are p1 and q1, respectively, and the reached values p2 and q2 of the image illustrated in FIG. 3 are thus different. The variation in time of the transmittance of the liquid crystal panel represented by the solid line is referred to as a case 1, and the variation in time of the transmittance of the liquid crystal panel represented by the broken line is referred to as a case 2.

The dotted line (ideal line) represents a variation with time of the transmittance of an ideal liquid crystal panel having an infinite response speed (response time of 0). With the ideal liquid crystal panel, a set pixel value is responded in a time of 0 and a reached value “a” is reached, which does not cause crosstalk.

In this embodiment, the crosstalk amount representing the degree of crosstalk at one pixel in an image includes a difference between a time integration result of the transmittance of the liquid crystal panel taking the actual response speed into account and a time integration result of the transmittance of the ideal liquid crystal panel (for example, the crosstalk amount in the case 1 is represented by a part with horizontal lines and the crosstalk amount in the case 2 is represented by a part with hatched lines).

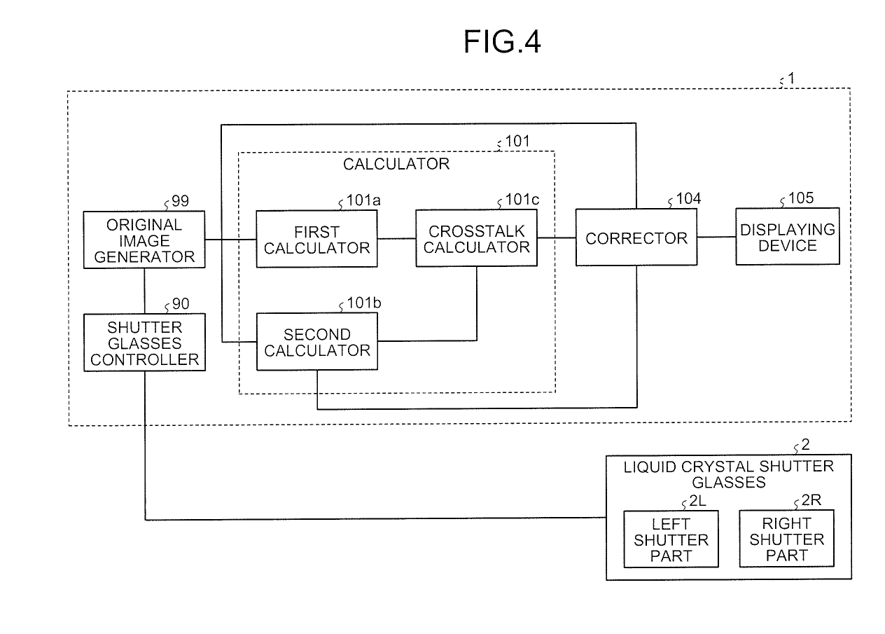

FIG. 4 is a block diagram illustrating a configuration of a stereoscopic video display system including the stereoscopic video display device 1. The stereoscopic video display device 1 includes an image generator 99, a shutter glasses controller 90, a calculator 101, a corrector 104 and the displaying device 105.

The image generator 99 generates right eye images and left eye images from video signals such as airwaves. The image generator 99 alternately outputs the right eye images and the left eye images. For example, when an n-th output image is a right eye image, an (n−1)-th image and an (n+1)-th image are left eye images. Each pixel in an image includes information of a pixel value. The shutter glasses controller 90 controls opening and closing of the liquid crystal shutter glasses 2 in synchronization with the outputs.

The calculator 101 calculates the crosstalk amount. The crosstalk calculator 101 includes a first calculator 101a, a second calculator 101b and a crosstalk calculator 101c. In this embodiment, an image input from the image generator 99 will be hereinafter referred to as an original image. In this embodiment, an n-th original image to be presented to either one of the left and right eyes input from the image generator 99 will be described as an image to be processed.

The first calculator 101a calculates, for each pixel of an n-th original image to be processed, a first luminance evaluation value in a case where the displaying device 105 including a liquid crystal panel having an infinite response speed (response time of 0). The second calculator 101b calculates a pixel value of an (n−1)-th corrected image and a second luminance evaluation value in a case where the response speed of the liquid crystal panel is taken into account for each pixel of the n-th original image to be processed. The (n−1)-th corrected image refers to an image obtained by correcting the (n−1)-th original image by the corrector that will be described later.

The crosstalk calculator 101c calculates the crosstalk amount from a difference between the first luminance evaluation value and the second luminance evaluation value. The corrector 104 generates a corrected image for each pixel from the crosstalk amount and the pixel value of the n-th original image to be processed. The corrector 104 outputs the corrected image to the displaying device 105 and feeds back the corrected image to the second calculator.

The first calculator 101a, the second calculator 101b, the crosstalk calculator 101c and the corrector 104 are implemented by a central processing unit (CPU).

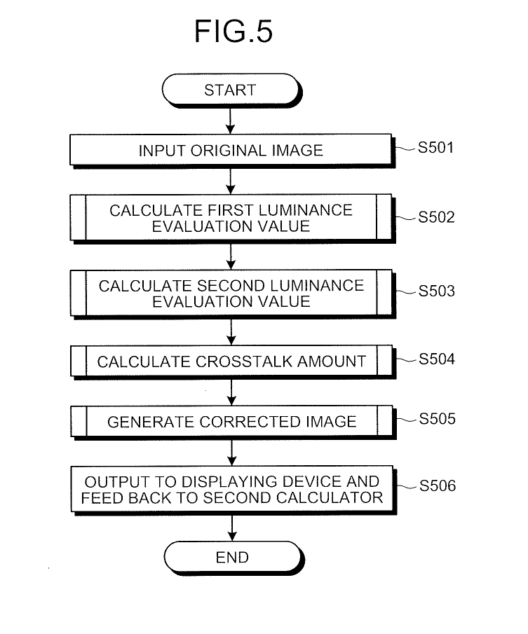

FIG. 5 is a flowchart illustrating processes of the stereoscopic video display device 1.

The same original image is input to the first calculator 101a and the second calculator 101b from the original image generator 99 (S501). In addition, an (n−1)-th corrected image is input to the second calculator 101b from the corrector 104. The first calculator 101a calculates a first luminance evaluation value for each pixel from characteristics data of the backlight and the characteristics data of the liquid crystal shutter glasses 2 without taking the pixel value of the original image and the response speed of the liquid crystal panel into account (S502). The second calculator 101b calculates a second luminance evaluation value for each pixel from the pixel value of the original image, the response speed of the liquid crystal panel, the characteristics data of the backlight, the characteristics data of the liquid crystal shutter glasses 2 and the pixel value of the (n−1)-th corrected image (S503).

The crosstalk calculator 101c calculates a crosstalk amount for each pixel from the first luminance evaluation value and the second luminance evaluation value (S504). The corrector 104 corrects each pixel of the original image by using the crosstalk amount to generate a corrected image (S505). The corrector 104 outputs the corrected image to the displaying device 105 and feeds back the corrected image to the second calculator 101b (S506). The corrected image is used by the second calculator to calculate a second luminance evaluation value from an (n+1)-th original image.

The stereoscopic video display device 1 will be described in detail below.

The same n-th original image is input to the first calculator 101a and the second calculator 101b from the original image generator 99. An original image has W [pixel] pixels in the horizontal direction and H [pixel] pixels in the vertical direction. The position of one pixel in a pixel coordinate system is defined as (x, y). One pixel includes three primary colors of red (R), green (G) and blue (B). In this embodiment, the three primary colors are expressed in integer values c. In this embodiment, it is assumed as follows: c=0 for blue (B), c=1 for green (G) and c=2 for red (R). The pixel value of each pixel in the n-th input original image will be hereinafter represented by Iₙ(x, y, c).

The shutter glasses controller 90 controls opening and closing of the left and right shutter parts 2L and 2R of the liquid crystal shutter glasses 2 in accordance with the display of the displaying device 105. Specifically, the shutter glasses controller 90 opens the right shutter part 2R and closes the left shutter part 2L of the liquid crystal shutter glasses 2 while the displaying device 105 displays a corrected image to be presented to the right eye. The same applies to the case where right and left are reversed.

The shutter glasses controller 90 is included in the stereoscopic video display device 1 and may control the liquid crystal shutter glasses 2 by transmitting synchronizing signals to a receiver included in the liquid crystal shutter glasses 2 through wired or wireless connection.

The first calculator 101a stores in advance characteristics data of the backlight and the liquid crystal shutter glasses 2. Examples of the characteristics data of the backlight include a light emission luminance B (x, y, t) of a backlight 105. Examples of the characteristics data of the liquid crystal shutter glasses 2 include a transmittance G(t) of the liquid crystal shutter glasses 2 (the transmittance of the right shutter part 2R is represented by G_{R}(t) and the transmittance of the left shutter part 2L is represented by G_{L}(t)).

As for the time t, the time at which the displaying device 105 starts displaying the n-th corrected image is defined to t=0 and the time at which the displaying device 105 starts displaying the (n+1)-th corrected image is defined to t=T_{MAX}.

B(x, y, t) is a function representing the light emission luminance of the backlight 105 to a pixel at a position (x, y) at time t. B(x, y, t) may be defined as a theoretical function or may be defined by experiments. In this embodiment, a light emission luminance B_{L}(x, y, t) of the backlight 105 that is defined in advance by experiments is used as B(x, y, t). B_{L}(x, y, t) is normalized to satisfy 0<=B_{L}(x, y, t)<=1. Note that “a left-hand side value <= a right-hand side value” means that “the left-hand side value is equal or smaller than the right-hand side value”.

G_{R}(t) represents a transmittance of the right shutter part 2R of the liquid crystal shutter glasses 2 at a certain time t. G_{L}(t) represents a transmittance of the left shutter part 2L of the liquid crystal shutter glasses 2 at a certain time t. G_{R}(t) and G_{L}(t) may be defined as theoretical functions or may be defined by experiments. In the present embodiment, G_{R}(t) and G_{L}(t) that are defined in advance by experiments are used. G_{R}(t) and G_{L}(t) are normalized to satisfy 0<=G_{R}(t)<=1 and 0<=G_{L}(t)<=1, respectively.

The first calculator 101a calculates, for each pixel of an n-th original image to be processed, a first luminance evaluation value E₁(x, y, c) representing the luminance evaluation value of a pixel in a case where a displaying device 105 including a liquid crystal panel having an infinite response speed (response time of 0) by using Equation (1).

E₁(x,y,c)=∫₀^{T}^{_{MAX}}B(x,y,t)×L(x,y,t,c)×G(t)dt (1)

Lₙ(x, y, c, t) is a function representing the transmittance of a panel 105 with respect to each color c of a pixel at a position (x, y) of the n-th original image to be processed at a certain time t. The first calculator 101a uses a function Yₙ(x, y, c) resulting from gamma conversion of Iₙ(x, y, c) as Lₙ(x, y, c, t). Yₙ(x, y, c) is normalized to satisfy 0<=Yₙ(x, y, c)<=1.

If the original image input to the first calculator is a right eye image, the transmittance G_{R}(t) of the right shutter part 2R is used for the transmittance G(t) of the liquid crystal shutter glasses 2. If the original image is a left eye image, the transmittance G_{L}(t) of the left shutter part 2L is used therefor.

The first calculator 101a outputs E₁(x, y, c) that is the calculation result to the crosstalk calculator 101c.

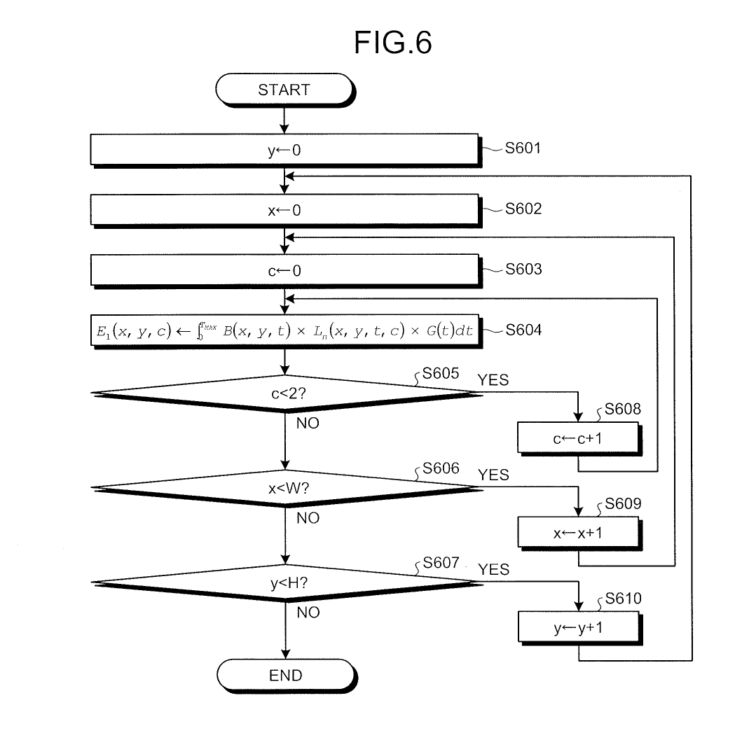

FIG. 6 is a flowchart illustrating processes of the first calculator 101a on the n-th original image to be processed.

The first calculator 101a assigns 0 to y so as to initialize y (S601). The first calculator 101a assigns 0 to x so as to initialize x (S602). The first calculator 101a assigns 0 to c so as to initialize c (S603). The first calculator 101a calculates E₁(x, y, c) by using Equation (1) (S604). The first calculator 101a determines whether or not c is smaller than 2 (S605). If c is determined to be smaller than 2, the first calculator 101a assigns c+1 to c (S608) and proceeds to step S604.

If c is determined not to be smaller than 2, the first calculator 101a determines whether or not x is smaller than W (S606). If x is determined to be smaller than W, the first calculator 101a assigns x+1 to x (S609) and proceeds to step S603. If x is determined not to be smaller than W, the first calculator 101a determines whether or not y is smaller than H (S607). If y is determined to be smaller than H, the first calculator 101a assigns y+1 to y (S610) and proceeds to step S602. If y is determined not to be smaller than H, the first calculator 101a terminates the processing.

An (n−1)-th corrected image is further input to the second calculator 101b from the corrector 104. The processes of the corrector 104 will be described later. The second calculator 101b calculates the second luminance evaluation value E₂(x, y, c) by Equation (2) for each pixel of the n-th original image to be processed.

E₂(x,y,c)=∫₀^{T}^{_{MAX}}B(x,y,t)×Lₙ(x,y,t,c)×G(t)dt (2)

The second calculator 101b differs from the first calculator 101a in the function used for the transmittance Lₙ(x, y, c, t) of the liquid crystal panel. The second calculator 101b uses a function taking the response speed of the liquid crystal panel 105 into account as Lₙ(x, y, c, t). Specifically, L(x, y, c, t) is expressed by using Equation (3).

Lₙ(x,y,c,t)=LCD(Lsₙ(x,y,c),Yₙ(x,y,c),t)(0≦t≦Tₘₐₓ) (3)

LCD(Lsₙ(x, y, c), Yₙ(x, y, c), t) is defined as follows. The transmittance of the liquid crystal panel at a position corresponding to a pixel of the n-th original image to be processed at a position (x, y) at a time point when the displaying device 105 starts displaying the pixel with a color c is represented by Lsₙx, y, c). LCD(Lsₙ(x, y, c), Yₙ(x, y, c), t) represents the transmittance of the

liquid crystal panel at a position corresponding to the pixel at a time t when the liquid crystal panel responds to the set transmittance Yₙ(x, y, c) from this state.

LCD (Lsₙ(x, y, c), Yₙ(x, y, c), t) is a model function set according to the response speed of the used liquid crystal panel. LCD (Lsₙ(x, y, c), Yₙ(x, y, c), t) is normalized to satisfy 0<=LCD (Lsₙ(x, y, c), Yₙ(x, y, c), t)<=1.

Lsₙ(x, y, c) is expressed by Equation (4).

Lsₙ(x,y,c)=LCD(Lsₙ₋₁(x,y,c),Uₙ₋₁(x,y,c),T_{MAX}) (4)

Uₙ₋₁(x, y, c) is a transmittance resulting from gamma conversion of a pixel value Oₙ₋₁(x, y, c) at a position (x, y) with a color c of the (n−1)-th corrected image determined by the corrector 104, which will be described later.

Specifically, Lsₙ(x, y, c) defined as above can be, in other words, a transmittance of the liquid crystal panel at a position corresponding to a pixel of the (n−1)-th corrected image at a position (x, y) with a color c at a time point when the display of the pixel ends. This value is an (n−1)-th reached value that corresponds to b1 or c1 in FIG. 2.

The second calculator 101b outputs Lsₙ(x, y, c) that is the calculation result to the crosstalk calculator 101c.

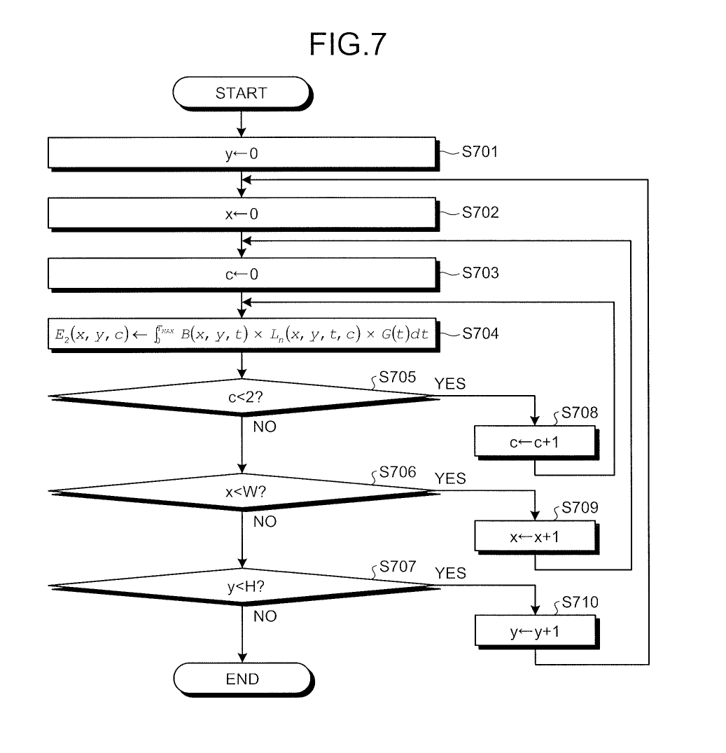

FIG. 7 is a flowchart illustrating processes of the second calculator 101b on the n-th original image to be processed.

The second calculator 101b assigns 0 to y so as to initialize y (S701). The second calculator 101b assigns 0 to x so as to initialize x (S702). The second calculator 101b assigns 0 to c so as to initialize c (S703). The second calculator 101b calculates E₂(x, y, c) by using Equation (2) (S704). The second calculator 101b determines whether or not c is smaller than 2 (S705). If c is determined to be smaller than 2, the second calculator 101b assigns c+1 to c (S708) and proceeds to step S704.

If c is determined not to be smaller than 2, the second calculator 101b determines whether or not x is smaller than W (S706). If x is determined to be smaller than W, the second calculator 101b assigns x+1 to x (S709) and proceeds to step S703. If x is determined not to be smaller than W, the second calculator 101b determines whether or not y is smaller than H (S707). If y is determined to be smaller than H, the second calculator 101b assigns y+1 to y (S710) and proceeds to step S702. If y is determined not to be smaller than H, the second calculator 101b terminates the processing.

The crosstalk calculator 101c calculates a crosstalk amount D (x, y, c) for each pixel by Equation (5) by using E₁(x, y, c) calculated by the first calculator 101a and E₂(x, y, c) calculated by the second calculator 101b.

D(x,y,c)=|E₁(x,y,c)−E₂(x, y, c)| (5)

The crosstalk calculator 101c outputs the crosstalk amount D(x, y, c) to the corrector 104.

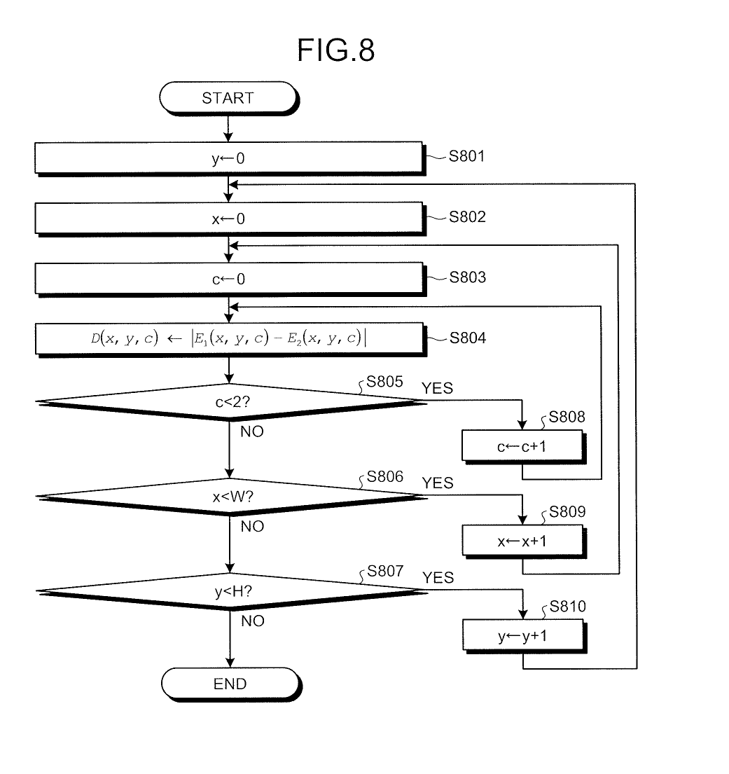

FIG. 8 is a flowchart illustrating processes of the crosstalk calculator 101c on the n-th original image to be processed.

The crosstalk calculator 101c assigns 0 to y to initialize y (S801). The crosstalk calculator 101c assigns 0 to x to initialize x (S802). The crosstalk calculator 101c assigns 0 to c to initialize c (S803). The crosstalk calculator 101c calculates D(x, y, c) by using Equation (5) (S804). The crosstalk calculator 101c determines whether or not c is smaller than 2 (S805). If c is determined to be smaller than 2, the crosstalk calculator 101c assigns c+1 to c (S808) and proceeds to step S804.

If c is determined not to be smaller than 2, the crosstalk calculator 101c determines whether or not x is smaller than W (S806). If x is determined to be smaller than W, the crosstalk calculator 101c assigns x+1 to x (S809) and proceeds to step S803. If x is determined not to be smaller than W, the crosstalk calculator 101c determines whether or not y is smaller than H (S807). If y is determined to be smaller than H, the crosstalk calculator 101c assigns y+1 to y (S810) and proceeds to step S802. If y is determined not to be smaller than H, the crosstalk calculator 101c terminates the processing.

The corrector 104 calculates a new pixel value Oₙ(x, y, c) resulting from correction of the pixel value of the n-th original image to be processed by Equation (6) by using the pixel value Iₙ(x, y, c) of each pixel of the n-th original image to be processed, the pixel value Iₙ₋₁(x, y, c) of each pixel of the (n−1)-th original image and a weighting function d(D(x, y, c)) dependent on the crosstalk amount D(x, y, c). The corrector 104 generates a corrected image resulting from correcting the n-th original image to be processed by using the determined Oₙ(x, y, c).

Oₙ(x,y,c)=Iₙ(x,y,c)×(1−d(D(x,y,c)))+Iₙ₋₁(x,y,c)×d(D(x,y,c)) (6)

d(D(x, y, c)) is normalized to satisfy 0<=d(D(x, y, c))<=1. d(D(x, y, c)) may be a linear function or a step function, for example.

Thus, the corrector 104 preferably stores therein the pixel value of the (n−1)-th original image. The corrector 104 feeds back the calculated Oₙ(x, y, c) to the second calculator 101b. The corrector 104 outputs the calculated Oₙ(x, y, c) to the displaying device 105. The displaying device 105 displays the corrected image.

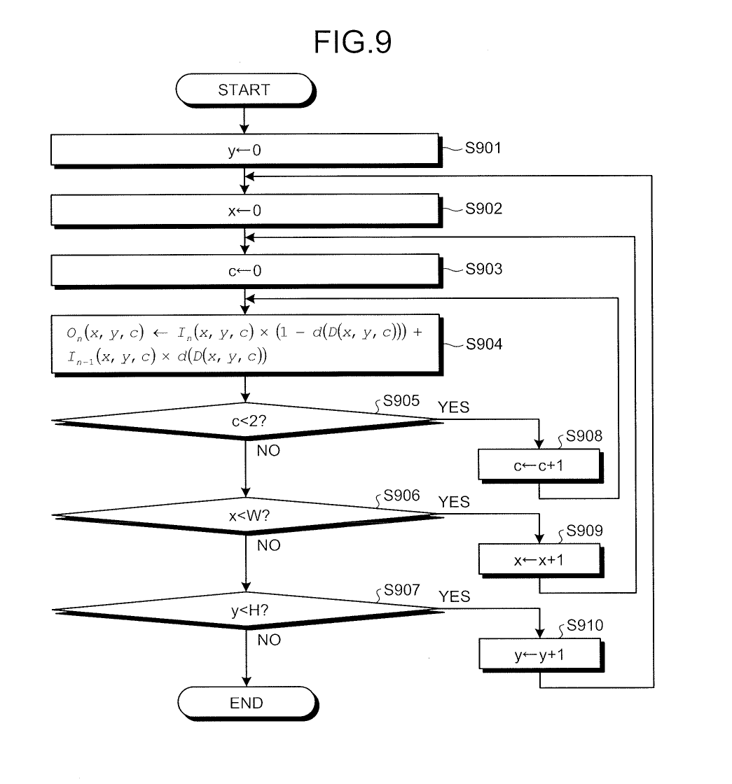

FIG. 9 is a flowchart illustrating processes of the corrector 104 on the n-th original image to be processed.

The corrector 104 assigns 0 to y so as to initialize y (S901). The corrector 104 assigns 0 to x so as to initialize x (S902). The corrector 104 assigns 0 to c so as to initialize c (S903). The corrector 104 calculates Oₙ(x, y, c) by using Equation (6) (S904). The corrector 104 determines whether or not c is smaller than 2 (S905). If c is determined to be smaller than 2, the corrector 104 assigns c+1 to c (S908) and proceeds to step S904.

If c is determined not to be smaller than 2, the corrector 104 determines whether or not x is smaller than W (S906). If x is determined to be smaller than W, the corrector 104 assigns x+1 to x (S909) and proceeds to step S903. If x is determined not to be smaller than W, the corrector 104 determines whether or not y is smaller than H (S907). If y is determined to be smaller than H, the corrector 104 assigns y+1 to y (S910) and proceeds to step S902. If y is determined not to be smaller than H, the corrector 104 terminates the processing.

As described above, the stereoscopic video display device 1 can accurately predict an actual crosstalk amount and correct the crosstalk.

While an example in which the viewer perceives stereoscopic images through the liquid crystal shutter glasses 2 worn by the viewer has been described, the present invention is not limited thereto and can also be applied to other stereoscopic video display device employing a time division system. For example, there are stereoscopic display devices employing a system in which a displaying device 105 displays images for one eye and images for the other eye having different polarizing directions from each other while switching between the images and a viewer views the images through polarized glasses worn by the viewer.

In this case, the first calculator 101a and the second calculator 101b calculates E₁(x, y, c) and E₂(x, y, c) without using G_{R}(t) and G_{L}(t). In this manner, the stereoscopic video display device 1 can perform processing similar to the above. Moreover, the shutter glasses controller 90 in FIG. 4 is not needed.

The displaying device 105 may be a plasma display. In this case, the first calculator 101 and the second calculator 101b calculates E₁(x, y, c) and E₂(x, y, c) by using a function of a variation of persistence with time of each pixel instead of using B(x, y, t) and L(x, y, c, t). In this manner, the stereoscopic video display device 1 can perform processing similar to the above.

### Second Embodiment

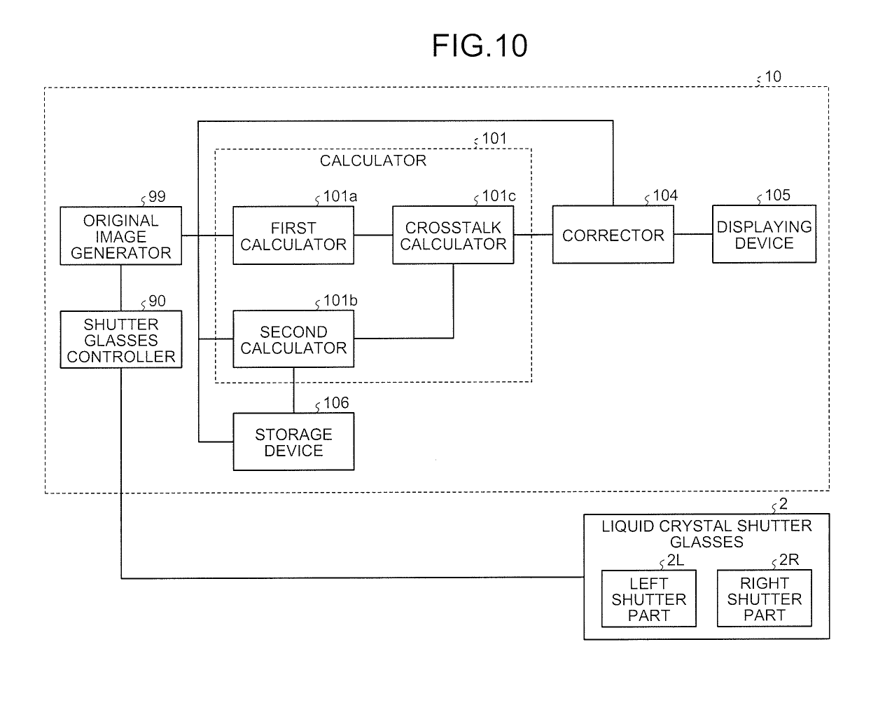

FIG. 10 is a block diagram illustrating a configuration of a stereoscopic video display system including a stereoscopic video display device 10 according to a second embodiment.

The stereoscopic video display device 10 further includes a storage device 106 in addition to the configuration of the stereoscopic video display device 1 according to the first embodiment. In the stereoscopic video display device 10, the second calculator 101b calculates a second luminance evaluation value E₂(x, y, c) by using a pixel value Iₙ₋₁(x, y, c) of an (n−1)-th original image instead of using an (n−1)-th corrected image generated by the corrector 104.

The storage device 106 stores the pixel value Iₙ₋₁(x, y, c) of the (n−1)-th original image. The second calculator 101b calculates E₂(x, y, c) by Equation (3) and Equation (7).

Lsₙ(x,y,c)=LSD(Lsₙ₋₁(x,y,c),Yₙ₋₁(x,y,c),T_{MAX}) (7)

As a result, it is possible to reduce the time cost for the processing.

### Third Embodiment

A stereoscopic video display device 100 (not illustrated) according to a third embodiment has the same configuration as the stereoscopic video display device 10 according to the second embodiment but differs therefrom in contents stored in the storage device 106.

The storage device 106 stores a translation table associating in advance the pixel value Iₙ(x, y, c) of an n-th original image input from the original image generator 99, the pixel value R(x, y, c) of a reference image, which will be described later, and the second luminance evaluation value E₂(x, y, c).

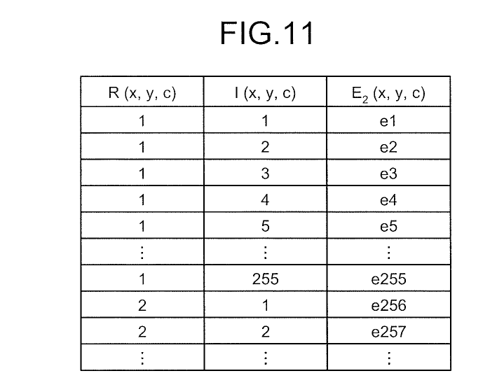

FIG. 11 is a diagram illustrating an example of the translation table to E₂(x, y, c). The pixel value R(x, y, c) of the reference image is the pixel value Iₙ₋₁(x, y, c) of the (n−1)-th original image, for example. In this case, the second calculator 101b uses the translation table to search for and extract a second luminance evaluation value E₂(x, y, c) associated with the pixel value Iₙ(x, y, c) of the input n-th original image and the pixel value Iₙ₋₁(x, y, c) of the (n−1)-th original image.

For example, when Iₙ(x, y, c) is 1 and R(x, y, c) (Iₙ₋₁(x, y, c)) is 5, the second calculator 101b extracts e5 as the value of E₂(x, y, c) by using the translation table.

As a result, the stereoscopic video display device 100 need not calculate E₂(x, y, c) and can thus reduce the processing cost.

### Fourth Embodiment

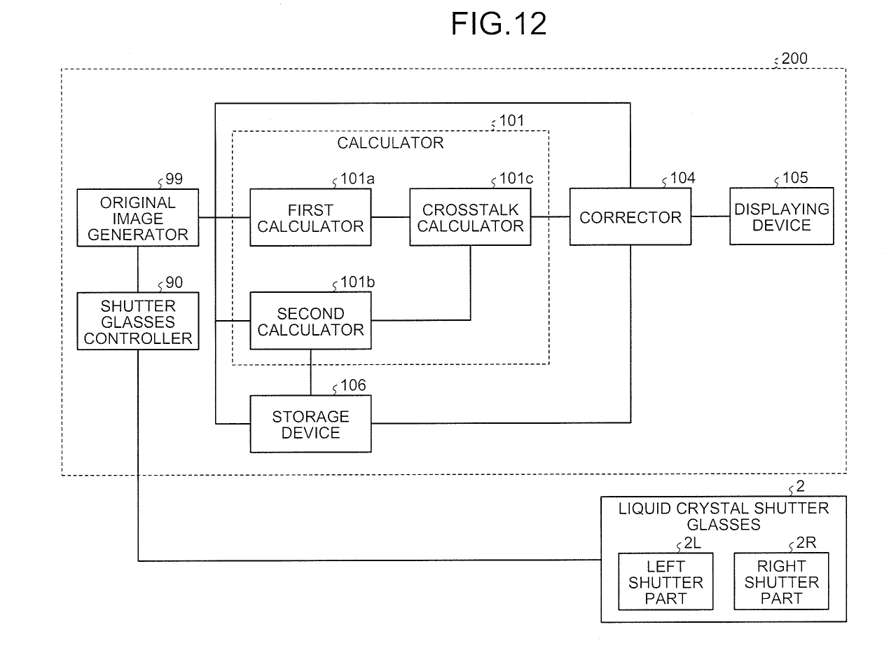

FIG. 12 is a block diagram illustrating a configuration of a stereoscopic video display system including a stereoscopic video display device 200 according to a fourth embodiment.

A storage device 106 in the stereoscopic video display device 200 uses a translation table similar to that in the third embodiment but differs therefrom in that the pixel value R(x, y, z) of a reference image is the pixel value Oₙ₋₁ of the (n−1)-th corrected image determined by the corrector 104. In this case, the second calculator 101b uses the translation table to search for and extract a second luminance evaluation value E₂(x, y, c) associated with the pixel value Iₙ(x, y, c) of the input n-th original image and the pixel value Oₙ₋₁(x, y, c) of the (n−1)-th corrected image.

As a result, the stereoscopic video display device 200 need not calculate E₂(x, y, c) and can thus reduce the

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereoscopic video display device that displays images for a plurality of view point directions on a displaying device while switching between the images at predetermined time intervals, comprising:
a calculator configured to calculate a crosstalk amount of a first image for one view point direction, which is an image to be corrected, by using a pixel value of the first image, a pixel value of a second image for a view point direction different from that of the first image, the second image being an image to be displayed at a time before the first image, and characteristics data including response characteristics of the displaying device; and
a corrector configured to correct the first image by using the crosstalk amount.

2. The device according to claim 1, wherein the second image is an image that has been displayed immediately before the first image.

3. The device according to claim 2, wherein the second image is a corrected image obtained by correcting the image that has been displayed immediately before the first image by the corrector.

4. The device according to claim 3, wherein
the displaying device is a liquid crystal display including a liquid crystal panel, and
the pixel value of the second image is a pixel value corresponding to a transmittance of the liquid crystal panel at a time point when the displaying device ends display of the corrected image.

5. The device according to claim 4, wherein
the displaying device further includes a backlight, and the calculator calculates, for each pixel, a first luminance evaluation value from the pixel value of the first image and characteristics data of the backlight, and calculates, for each pixel, a second luminance evaluation value from the pixel value of the first image, the pixel value of the second image, the characteristics data of the backlight and characteristics data of the liquid crystal panel, and calculates a crosstalk amount from a difference between the first luminance evaluation value and the second luminance evaluation value.

6. The device according to claim 5, wherein the corrector corrects the first image by multiplying the pixel value of the first image and the pixel value of the second image by a weighting function dependent on the crosstalk amount.
